(19) United States
(12) Patent Application Publication
(10) Pub. No.: US 2021/0409952 A1
(43) Pub. Date: Dec. 30, 2021

(54) Security Parameter Negotiation in a Wireless Communication System

(71) Applicant: Telefonaktiebolaget LM Ericsson (publ), Stockholm (SE)

(72) Inventors: Christine Jost, Lund (SE); Helena Vahidi Mazinani, Lund (SE)

(21) Appl. No.: 17/293,074

(22) PCT Filed: Nov. 5, 2019
(86) PCT No.: PCT/EP2019/080219

§ 371 Date: May 12, 2021

Related U.S. Application Data
(60) Provisional application No. 62/758,742, filed on Nov. 12, 2018.

(51) Int. Cl. H04W 12/106; H04W 12/06; H04W 12/041

(52) U.S. Cl. CPC H04W 12/106; H04W 12/041; H04W 12/06

(57) ABSTRACT

The invention relates to a method is performed by a wireless device. The method comprises transmitting (step 1), by the wireless device, capability signaling which indicates one or more values that the wireless device supports for a security parameter. The method further comprises receiving (step 7), by the wireless device, selection signaling that indicates a value selected (step 4a) by a home network of the wireless device for the security parameter and that includes integrity-checking information (step 4c). The method further comprises checking (step 10), using the integrity-checking information and a security key shared with the home network, an integrity of integrity-protected information, wherein the integrity-protected information includes the capability signaling as received by the home network.

### TECHNICAL FIELD

The present disclosure relates to methods and apparatus for security of wireless communications, especially for security parameter negotiation in a wireless communication system.

### BACKGROUND

Security of wireless communications is typically founded on a shared secret between a wireless device and the wireless communication network. Based on that shared secret, further parameters for securing the communications may be negotiated or derived. Although security parameter negotiation may establish parameters for securing later communications, challenges exist in securing the actual security parameter negotiation.

### SUMMARY

Some embodiments herein advantageously secure or otherwise protect security parameter negotiation itself between a wireless device and its home network, e.g., against a bidding-down attack or other type of man-in-the-middle attack. Some embodiments thereby provide such protection even between the wireless device and its home network, e.g., which may be in addition to any such protection between the wireless device and the visited network as applicable. The embodiments may accordingly guard against a compromised visited network and/or compromised transport between the visited network and the home network.

In this regard, the security parameter negotiation in some embodiments involves the wireless device transmitting capability signalling to the home network indicating which value(s) the device supports for a security parameter. Some embodiments herein protect the security parameter negotiation itself by enabling the wireless device to verify that the home network received the capability signalling that the wireless device transmitted with its integrity in act. That is, some embodiments enable the wireless device to verify that the capability signalling transmitted by the wireless device was not modified by a man-in-the middle between the wireless device and the home network, e.g., that attempts to fool the home network into believing that the wireless device is only capable of using certain values for the security parameter (e.g., legacy values) that may be less secure. Some embodiments notably do so by leveraging a (pre)shared security key for integrity protection.

More particularly, some embodiments include a method performed by a wireless device. The method may comprise transmitting, by the wireless device, capability signaling which indicates one or more values that the wireless device supports for a security parameter (e.g., a key derivation function, KDF). The method may also include receiving, by the wireless device, selection signaling that indicates a value selected by a home network of the wireless device for the security parameter and that includes integrity-checking information. The method in some embodiments may also include checking, using the integrity-checking information and a security key shared with the home network, an integrity of integrity-protected information. The integrity-protected information includes (at least) the capability signaling as received by the home network.

Embodiments also include a method performed by network equipment configured for use in a home network of a wireless device. The method comprises receiving, by the network equipment, capability signaling which indicates one or more values that a wireless device supports for a security parameter. The method also comprises selecting, by the network equipment for the home network, a value for the security parameter from among the one or more values that the wireless device supports for the security parameter. The method may also comprise generating a security key shared with the wireless device. The method may further comprise generating, using at least the received capability signaling and the security key, integrity-checking information based on which is checkable an integrity of integrity-protected information. The integrity-protected information includes (at least) the capability signaling as received by the network equipment. The method may then include transmitting selection signaling that indicates the value selected for the security parameter and that includes the integrity-checking information.

Embodiments also include a wireless device. The wireless device comprises processing circuitry and memory. The memory contains instructions executable by the processing circuitry whereby the wireless device is configured to transmit, by the wireless device, capability signaling which indicates one or more values that the wireless device supports for a security parameter (e.g., a key derivation function, KDF). The wireless device may also be configured to receive, by the wireless device, selection signaling that indicates a value selected by a home network of the wireless device for the security parameter and that includes integrity-checking information. The wireless device in some embodiments may also be configured to check, using the integrity-checking information and a security key shared with the home network, an integrity of integrity-protected information. The integrity-protected information includes (at least) the capability signaling as received by the home network.

Embodiments also include network equipment configured for use in a home network of a wireless device. The network equipment comprises processing circuitry and memory. The memory contains instructions executable by the processing circuitry whereby the wireless device is configured to receive, by the network equipment, capability signaling which indicates one or more values that a wireless device supports for a security parameter. The network equipment may also be configured to select, by the network equipment for the home network, a value for the security parameter from among the one or more values that the wireless device supports for the security parameter. The network equipment may also be configured to generate a security key shared with the wireless device. The network equipment may also be configured to generate, using at least the received capability signaling and the security key, integrity-checking information based on which is checkable an integrity of integrity-protected information. The integrity-protected information includes (at least) the capability signaling as received by the network equipment. The method may then include transmit selection signaling that indicates the value selected for the security parameter and that includes the integrity-checking information.

Embodiments also include corresponding computer programs and carriers. A computer program comprises instructions which, when executed on at least one processor of an apparatus, cause the apparatus to carry out any of the embodiments described above. Embodiments further include a carrier containing such a computer program. This carrier may comprise one of an electronic signal, optical signal, radio signal, or computer readable storage medium.

### BRIEF DESCRIPTION OF THE DRAWINGS

The inventive concept is now described, by way of example, with reference to the accompanying drawings, in which:

FIG. 1 is a block diagram of a wireless communication system according to some embodiments.

FIG. 2 is a block diagram for protecting the security parameter negotiation according to some embodiments.

FIG. 3 is a block diagram for protecting the security parameter negotiation according to some other embodiments.

FIG. 4 is a block diagram of entities used in a wireless communication system according to some embodiments.

FIG. 5 is a signaling diagram of security parameter negotiation performed as part of the authentication flows according to some embodiments.

FIG. 6 is a logic flow diagram of a method performed by a wireless device according to some embodiments.

FIG. 7 is a logic flow diagram of a method performed by network equipment according to some embodiments.

FIG. 8 is a block diagram of network equipment according to other embodiments.

FIG. 9 is a block diagram of a wireless device according to other embodiments.

FIG. 10 is a block diagram of a wireless network according to some embodiments.

FIG. 11 is a block diagram of a UE according to some embodiments.

FIG. 12 is a schematic block diagram illustrating a virtualization environment according to some embodiments

FIG. 13 is a block diagram of telecommunication network connected via an intermediate network to a host computer according to some embodiments.

FIG. 14 is a block diagram of a host computer communicating via a base station with a user equipment over a partially wireless connection according to some embodiments.

FIG. 15 is a flowchart illustrating a method implemented in a communication system, in accordance with one embodiment.

FIG. 16 is a flowchart illustrating a method implemented in a communication system, in accordance with one embodiment.

FIG. 17 is a flowchart illustrating a method implemented in a communication system, in accordance with one embodiment.

FIG. 18 is a flowchart illustrating a method implemented in a communication system, in accordance with one embodiment.

### DETAILED DESCRIPTION

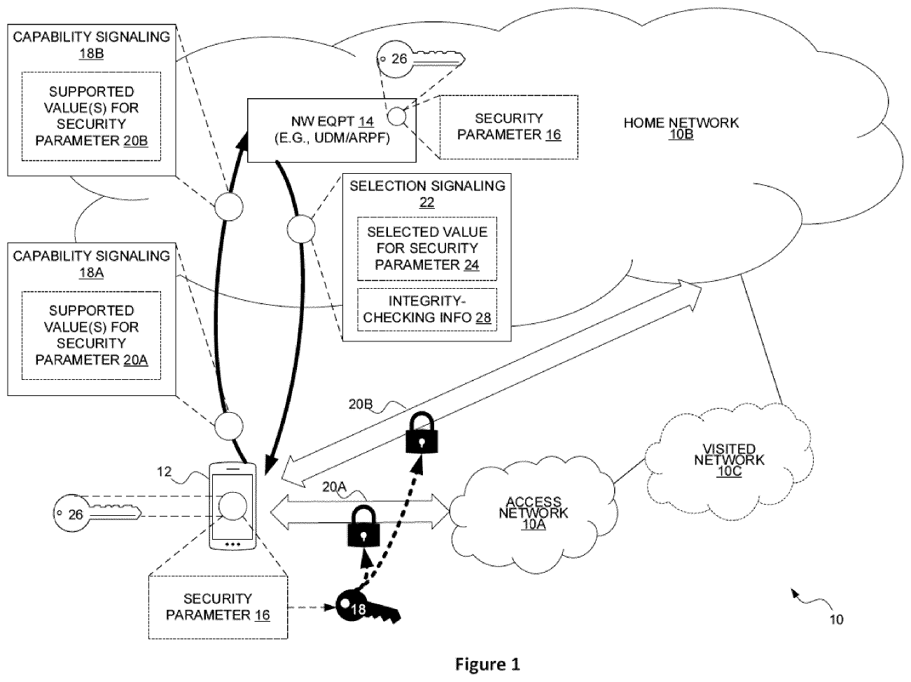

FIG. 1 shows a wireless communication system (e.g., a 5G system) 10 according to some embodiments. In the wireless communication system 10, a wireless device 12 wirelessly accesses an access network 10A which connects the wireless device 12 to core network equipment. In some embodiments, the access network 10A directly connects the wireless device 12 to a home network 10B of the wireless device 12 which includes at least some of this core network equipment. The home network 10B is the network to which the wireless device 12 is associated/related via a subscription. For example, where the wireless device 12 represents a mobile equipment (ME) that is configured to removably or integrally include therein an integrated circuit card or subscriber identity module, the integrated circuit card or subscriber identity module may store a subscriber identity that identifies the subscription to the home network 10B.

In other embodiments, though, the access network 10A directly connects the wireless device 12 to a visited network 10C that includes core network equipment which is local to the wireless device's access point. The visited network 10C however interconnects to the wireless device's home network 10B, e.g., to cater for user specific data/services.

Regardless, the wireless device 12 is configured to perform security parameter negotiation (e.g., key derivation function, KDF, negotiation) with the home network 10B. The security parameter negotiation is performed in order to negotiate a value to use for a security parameter 16. The security parameter 16 may for instance be a KDF such that the value used for the security parameter 16 indicates a type of KDF that the wireless device 12 and the home network 10B will use. In other examples, the security parameter 16 may be an integrity algorithm, an encryption algorithm, or a security protocol to use, such that the value used for the security parameter 16 indicates a type of integrity algorithm, a type of encryption algorithm, or a type of security protocol that the wireless device 12 and the home network 10B will use. No matter the particular nature of the security algorithm, though, the security parameter negotiation as shown in FIG. 1 involves the wireless device 12 transmitting capability signalling 18A to network equipment 14 in the home network 10B (e.g., implementing a unified data management, UDM, function and/or an authentication credential repository and processing function, ARPF). The capability signalling 18A indicates one or more values 20A that the wireless device 12 supports for the security parameter 16. For example, where the wireless device 12 represents a mobile equipment (ME) as described above, and where the security parameter is a KDF, the one or more values 20A may indicate one or more types of KDFs supported by the ME. Note in this regard that the home network 10B may already have stored subscriber information indicating the capabilities of the integrated circuit card or subscriber identity module associated with the subscription, but may not in fact have knowledge (absent the capability signalling 18A) about the capabilities of the ME itself. In any event, the network equipment 14 correspondingly receives capability signalling 18B from the wireless device 12. Based on the capability signalling 18B, the network equipment 14 selects a value for the security parameter 16 from among the one or more values 20B that the received capability signalling indicates 18B the wireless device 12 supports for the security parameter 16. The network equipment 14 thereafter transmits selection signalling 22 to the wireless device 12 indicating the value 24 selected for the security parameter 16.

Once negotiated in this way, the security parameter 16 may then be used for securing subsequent communications for the wireless device 12. For example, the wireless device 12 may use the negotiated value of the security parameter 16 (e.g., a KDF) to derive a security key 18. This security key 18, or a further derivative thereof, may be used to protect communications for the wireless device 12, e.g., communications 20A between the wireless device 12 and the access network 10A and/or communications 20B between the wireless device 12 and the home network 10B.

Some embodiments herein advantageously secure or otherwise protect the above-described security parameter negotiation itself, e.g., against a bidding-down attack or other type of man-in-the-middle attack. Some embodiments thereby provide such protection even between the wireless device 12 and its home network 10B, e.g., which may be in addition to any such protection between the wireless device 12 and the visited network 100 as applicable. The embodiments may accordingly guard against a compromised visited network 10C and/or compromised transport between the visited network 100 and the home network 10B.

In this regard, some embodiments herein protect the security parameter negotiation itself by enabling the wireless device 12 to verify that the network equipment 14 in the home network 10B received the capability signalling 18A that the wireless device 12 transmitted with its integrity in tact. That is, some embodiments enable the wireless device 12 to verify that the capability signalling 18A transmitted by the wireless device 12 was not modified by a man-in-the middle between the wireless device 12 and the network equipment 14, e.g., that attempts to fool the network equipment 14 into believing that the wireless device 12 is only capable of using certain values for the security parameter (e.g., legacy values) that may be less secure.

Some embodiments notably do so by leveraging a (pre)shared security key 26 for integrity protection. The security key 26 may be shared between the home network 10B and an integrated circuit card or subscriber identity module associated with the wireless device 12. The security key 26 may for instance be separately generated by the network equipment 14 and the integrated circuit card or subscriber identity module. In one or more embodiments, for example, the security key is an integrity key IK or a derivative thereof (e.g., IK′), a confidentiality key CK or a derivative thereof (e.g., CK′), or a combination of the integrity key IK and the confidentiality key CK (e.g., IK∥CK).

More particularly, the network equipment 14 according to some embodiments is configured to generate integrity-checking information 28 (e.g., in the form of a key, a hash, a message authentication code (MAC), a digital signature, or the like). The network equipment 14 generates this integrity-checking information 28 using (at least) the security key 26 and the capability signalling 18B that the network equipment 14 received. The network equipment 14 includes this integrity-checking information 28 in the selection signalling 22 that it transmits to the wireless device 12. The wireless device 12 then uses the security key 26 and the integrity-checking information 28 to check the integrity of the capability signalling 18B as received by the network equipment 14. Notably, then, the wireless device 12 effectively checks that the capability signalling 18B received by the network equipment 14 is the same as the capability signalling 18A transmitted by the wireless device 12.

The wireless device 12 in some embodiments uses the integrity-checking information 28 to not only check the integrity of the capability signalling 18B as received by the network equipment 14 but to also check the integrity of other information received by the network equipment 14 and/or information received by the wireless device 12. In one embodiment, for instance, the wireless device 12 also uses the integrity-checking information 28 to check the integrity of the value 24 that the selection signalling 22 received by the wireless device 12 indicates was selected by the home network 10B for the security parameter 16. Or, in fact, in embodiments where the wireless device 12 transmits the capability signalling 18A within a message (e.g., including other information as well), the wireless device 12 may use the integrity-checking information 22 to check the integrity of all or a portion of the message that includes the capability signalling as received by the network equipment 14. In these and other embodiments, then, the wireless device 12 herein may be generally said to use the integrity-checking information 28 to check the integrity of so-called integrity-protected information. This integrity-protected information includes at least the capability signalling 18B as received by the network equipment 14. In some embodiments, the integrity-protected information includes other information as described above (e.g., the value 24 indicated by the selection signalling 22, all or a portion of a message including the capability signalling, etc.).

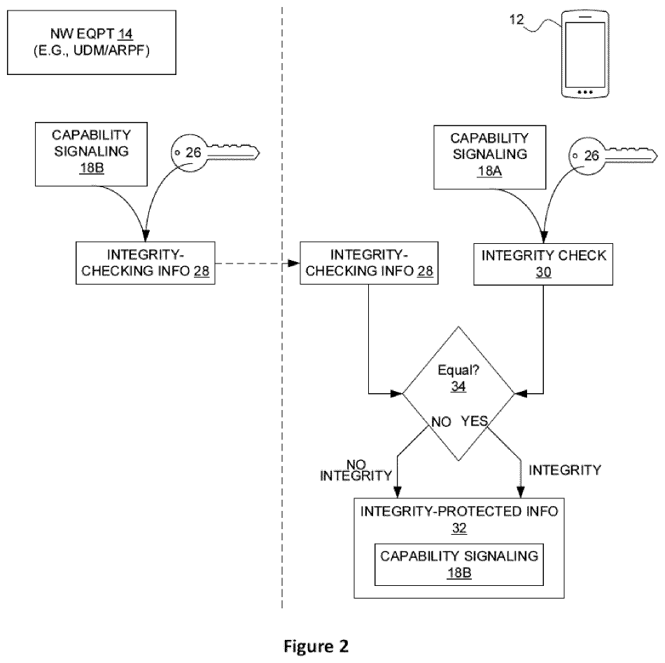

FIG. 2 illustrates additional details for how the network equipment 14 and the wireless device 12 use the security key 26 for protecting the security parameter negotiation. As shown, the network equipment 14 generates the integrity-checking information 28 using (at least) the security key 26 and the capability signalling 18B that the network equipment 14 received. The wireless device 12 uses at least the security key 26 and the capability signalling 18A that the wireless device 12 transmitted to compute an integrity check 30 (e.g., in the form of a key, a hash, a message authentication code (MAC), a digital signature, or the like). The wireless device 12 then determining whether or not the integrity-protected information 32 (including at least the capability signaling 18B) has integrity based respectively on whether or not the integrity check 30 equals (or corresponds to) the integrity-checking information 28. As shown, for instance, the wireless device 12 compares the integrity-checking information 28 to the integrity check 30 and determines whether they are equal (Block 34). If not (NO at block 34), the wireless device 12 determines that the capability signaling 18B received by the network equipment 14 lacked integrity. The wireless device 12 may then take appropriate action to handle the potential error or security compromise, e.g., abort or reject the security parameter negotiation. If the integrity-checking information 28 does equal the integrity check 30, though, (YES at block 34), the wireless device 12 determines that the capability signaling 18B received by the network equipment 14 had integrity. The wireless device 12 may then confidently accept the security parameter negotiation.

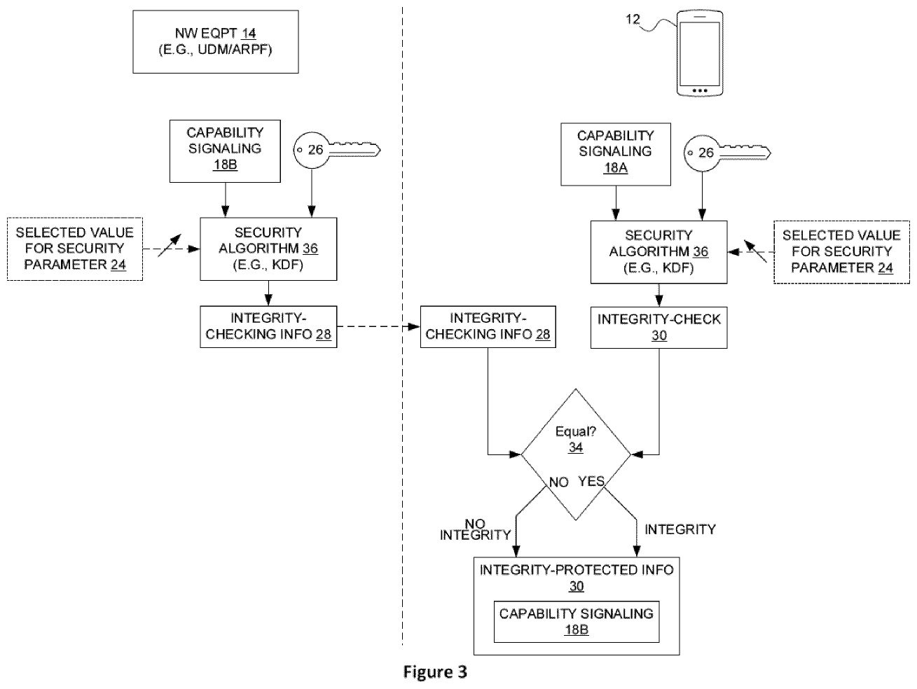

Protection of the security parameter negotiation may in other embodiments herein also leverage the value 24 selected by the home network 10B for the security parameter 16. For example, the network equipment 14 may generate the integrity-checking information 28 also using the value 24 selected by the home network 10B for the security parameter 16. And the wireless device 12 may check the integrity of the integrity-checking information 28 also using the value 24 selected by the home network 10B for the security parameter 16. For example, the wireless device 12 may compute the integrity check 30 using the value 24 selected by the home network 10B for the security parameter 16. FIG. 3 illustrates one or more of these embodiments. As shown in FIG. 3, the network equipment 14 generates the integrity-check information 28 using the received capability signalling 18B as input to a keyed version of a certain type of security algorithm 36 (e.g., a certain type of KDF, a certain type of message authentication code algorithm, a certain type of digital signature algorithm, etc.). The keyed version of the certain type of security algorithm 36 is keyed by the security key 26. Moreover, in some embodiments, the certain type of security algorithm 36 is indicated by the selection signalling 22. In fact, in one or more embodiments where the security parameter 16 is a security algorithm (e.g., KDF) such that the capability signalling 18B indicates one or more types of security algorithms supported by the wireless device 12, the value 24 selected by the home network 10B for the security parameter 16 indicates the certain type of security algorithm 36 to use for generating the integrity-checking information 28. Correspondingly, the wireless device 12 computes the integrity check 30 using the transmitted capability signalling 18A as input to a keyed version of the certain type of security algorithm that is indicated by the value 24 selected by the home network 10B for the security parameter 16 and that is keyed by the shared security key 26.

For example, in some embodiments, the security algorithm 36 is a KDF of the form: derived key=KDF(Key, S). Here, the certain type of KDF applied (e.g., HMAC-SHA-256 or another type) depends on the value 24 selected by the home network 10B for the security parameter. The derived key is the output of the KDF, e.g., integrity-checking information 28 at the network equipment 14 and the integrity check 30 at the wireless device 30. The Key is the security key 26. And S is an input string constructed from one or more input parameters. The input parameter(s) include (at least) the received capability signalling 18B at the network equipment 14 and include (at least) the transmitted capability signalling 18A at the wireless device 12.

Although the security parameter negotiation described above may be performed in a procedure dedicated to such negotiation, other embodiments herein leverage an authentication procedure between the wireless device 12 and the home network 10B for such security parameter negotiation. For example, in some embodiments, the authentication procedure is triggered by the wireless device 12 transmitting a registration request message or an attach request message that requests registration or attachment with the system 10. In one or more such embodiments, the wireless device 12 may include the capability signalling 18A within this registration request message or attach request message. This capability signalling 18A may be propagated (e.g., via one or more messages, potentially of different types) to the network equipment 14 as part of the authentication procedure. For example, in some embodiments, the network equipment 14 receives an authentication get request message (e.g., Nudm_UEAuthentication_Get Request) that requests authentication information from the network equipment 14 and that includes the capability signalling 18B. In these and other examples, the network equipment 14 may retrieve the capability signalling 18B and respond with an authentication request message (e.g., an extensible authentication protocol, EAP, request message, an AKA′ challenge message, or any other type of message requesting authentication) that includes the selection signalling 22 and that requests the wireless device 12 to authenticate itself to the home network 1B. Correspondingly, the wireless device 12 may receive the selection signalling 22 within such an authentication request message.

Consider an example of these embodiments that leverage the authentication procedure in the context of a 5G or New Radio (NR) system. In the example below, the wireless device 12 represents an ME as described above, the network equipment 14 corresponds to network equipment implementing a UDM and/or ARPF, and the security parameter is an ARPF-KDF or an Authentication Server Function, AUSF-KDF. In particular, key derivation functions are used in many places in 3GPP networks. Both the 4G and 5G system as currently standardized use a fixed KDF, namely SHA-256. However, allowing the mobile equipment (ME) and the home network to negotiate which KDF(s) would enable more flexible and adaptable KDF usage, e.g., for introducing new KDFs which may be developed in the future. But since the KDF(s) are used for generating security keys that protect communications between the network and the wireless device, challenges exist in securing the actual KDF negotiation. Existing KDF negotiation solutions, such as Solution #1.29 in TR 33.899 and S3-080963, fall short in this regard.

Some embodiments herein secure KDF negotiation between ME and the home network (e.g., the home public land mobile network, HPLMN,), e.g., as described for the 5G system. Some embodiments for example include bidding-down protection for the KDF negotiation, even with respect to the home network. One or more such embodiments do so using the authentication mechanism for the KDF negotiation. That is, some embodiments use the authentication procedure to negotiate KDFs between home network and ME.

Some embodiments have one or more of the following technical advantages: (i) takes ME and HPLMN capabilities into account; (ii) uses authentication mechanism, hence takes place when keys are provisioned from HPLMN to VPLMN; (iii) Adapted to the authentication for the 5G system; (iv) Includes feature for bidding-down protection, even with respect to the home network; and (v) avoids use of scarce authentication management field (AMF) bits.

More particularly, the authentication procedure is used in some embodiments to negotiate KDFs between home network and ME. Some embodiments below describe the procedures used in the 5G system. However, this kind of description does not preclude other embodiments to be used for other generations of 3GPP networks. The AMF/SEAD could be any function in the visited network that forwards authentication related messages between ME and home network. The UDM/ARPF could be any authentication endpoint in the home network. The AUSF could be any non-endpoint authentication function in the home network.

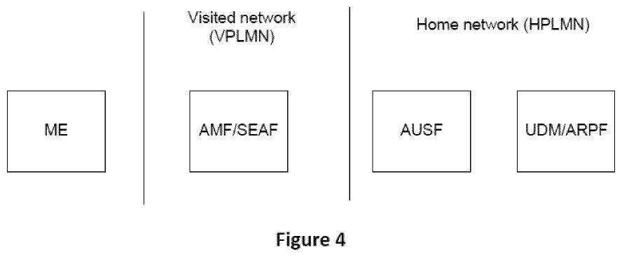

With regard to the 5G system, though, FIG. 4 shows the entities used in the following description of some embodiments. Here, the ME is the mobile equipment, the AMF/SEAF is the Access and Mobility Management Function/SEcurity Anchor Function in the visited network (VPLMN), the AUSF is the Authentication Server Function in the home network (HPLMN), and the ARPF is the Authentication credential Repository and Processing Function in the home network. They are all described in detail in 3GPP TS 33.501 v 15.2.0.

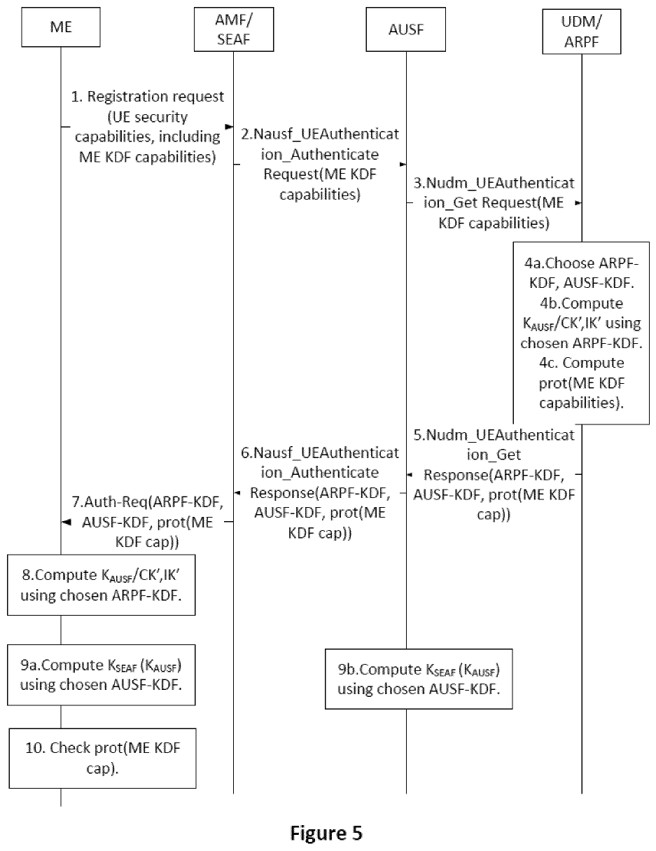

FIG. 5 is a call flow diagram for some embodiments herein where the security parameter negotiated is a KDF and where the negotiation is performed as part of the authentication flows in clauses 6.1.3.1 and 6.1.3.2 in 3GPP TS 33.501 v 15.2.0. Clause 6.1.3.1 describes authentication for the 5GS using EAP-AKA′. Clause 6.1.3.2 describes authentication using 5G AKA. Whenever a difference between EAP-AKA′ and 5G AKA is relevant for these embodiments, it is mentioned. Otherwise, the embodiments hold for both authentication procedures for the 5GS.

Step 1: The ME sends a registration request to the AMF/SEAF, e.g., as described in clause 4.2.2.2.2 of 3GPP TS 23.502. It includes, as an example of capability signaling 18A in FIG. 1, the ME's KDF capabilities (information which KDFs the ME supports), for example as part of the security capabilities.

Step 2: The AMF/SEAF sends a Nausf_UEAuthenticate Request to the AUSF. It includes the ME's KDF capabilities.

Step 3. The AUSF sends a Nudm_UEAuthentication_Get Request to the UDM/ARPF. It includes the ME's KDF capabilities.

Step 4a. The UDM/ARPF chooses an ARPF-KDF and an AUSF-KDF out of the KDFs that the ME supports. The chosen ARPF-KDF and/or AUSF-KDF in this case represents an example of the selected value for the security parameter 24. In any event, the UDM/ARPF may choose the one that has highest priority according to a list provisioned by the home operator. One possible option is that several ARPF-KDFs and/or AUSF-KDFs are chosen, which are to be used for different key derivations or other uses in the ARPF and/or AUSF.

Step 4b. The UDM/ARPF computes the K_{AUSF} (if 5G AKA is used) or CK′/IK′ (if EAP-AKA′ is used) using the chosen ARPF-KDF.

Step 4c. The UDM/ARPF may also compute, as an example of integrity-checking information 28, prot(ME KDF capabilities). The UDM/ARPF may do so by applying a keyed version of a chosen ARPF-KDF to the ME KDF capabilities. As an option, the keyed versions of all KDFs supported by ARPF and ME are computed and combined by XOR or concatenation to compute prot (ME KDF capabilities).

In this step 4c, the ARPF in a general sense integrity protects the UE security capabilities, using a key derived in the ongoing authentication procedure.

Option space 1: The key used for the integrity protection could for example be the IK, the CK|IK, or a key derived from the CK and/or IK

Option space 2: The integrity protection could be performed using one of the following methods:

KDF supported by both ME and ARPF, most probably the one that the ARPF decided to use in the ongoing negotiation. For example, the rel-15 5G system uses HMAC-SHA-256 based on SHA-256. It could also be some other hash-based MAC, or some other KDF such as HKDF.

Other MACs supported by both ME and ARPF, for example MACs derived from a block cipher such as CMAC, or for example GMAC

Possibly also a digital signature algorithm supported by both ME and ARPF

Option space 3: Instead of relying on only one integrity protection algorithm, several or all of the algorithms that both ME and ARPF support could be combined to produce the integrity protection tag. For example, the algorithms could be concatenated, or the results of the algorithms could be XORed.

Step 5. The UDM/ARPF sends a Nudm_UEAuthentication_Get Response to the AUSF. It includes the chosen ARPF-KDF(s) and AUSF-KDF(s), as an example of the selected value for the security parameter 24. It also includes prot(ME KDF capabilities) if computed in Step 4c. Note that, in at least some embodiments, the prot(ME KDF capabilities) is signaled separately from any authentication management field (AMF) included in the response (e.g., included in an authentication token, AUTN, signaled in the response). The AMF may for instance indicate the algorithm and key used to generate a particular authentication vector, AV, when multiple algorithms and keys are used.

Step 6. The AUSF sends a Nausf_UEAuthentication_Authenticate Response to the AMF/SEAF. It includes chosen ARPF-KDF(s) and AUSF-KDF(s). It also includes prot(ME KDF capabilities) if received in Step 5.

Step 7. The AMF/SEAF sends an Authentication Request to the ME. It includes chosen ARPF-KDF(s) and AUSF-KDF(s). It also includes prot(ME KDF capabilities) if received in Step 5

Step 8. The ME computes the K_{AUSF} (if 5G AKA is used) or CK′/IK′ (if EAP-AKA′ is used) using the chosen ARPF-KDF.

Step 9a. The ME computes the K_{SEAF} and K_{AUSF} (the latter if EAP-AKA′ is used) using the chosen AUSF-KDF.

Step 9b. The AUSF computes the K_{SEAF} and K_{AUSF} (the latter if EAP-AKA′ is used) using the chosen AUSF-KDF.

Step 10. The ME computes, as an example of integrity check 30, prot(ME KDF capabilities) in the same way as the UDM/ARPF in Step 4c. The ME compares its own computed value with the value received from the AMF/SEAD in Step 7.

Note that Step 9a can be performed at any time after Step 5.

Note also that Steps 1, 2, 3, 4a, 5, 6, 7 are the actual negotiation of KDFs. Steps 4b, 8, 9a and 9b are the following key derivations using the negotiated KDFs. Steps 4c and 10 describe the additional feature against bidding-down protection.

Note that although some of the embodiments described above were described for negotiating KDF, the embodiments may be extendable to any type of security parameter. Exemplary security parameters include for instance KDFs, encryption algorithms, integrity algorithms, and/or other supported security protocols.

Also note that, although the above embodiments were exemplified as applicable in certain contexts and/or wireless network types (e.g., 5G or New Radio, NR) for illustrative purposes, the embodiments are similarly applicable in other contexts and/or wireless network types not explicitly described.

In view of the above modifications and variations, FIG. 6 depicts a method performed by a wireless device 12 (e.g., UE or ME) accordance with particular embodiments. The method as shown may include transmitting, by the wireless device, capability signaling which indicates one or more values that the wireless device (e.g., ME) supports for a security parameter (e.g., a KDF) (Block 600). The method also includes receiving, by the wireless device, selection signaling that indicates a value selected by a home network of the wireless device for the security parameter and that includes integrity-checking information (Block 610). The method in some embodiments may further include checking, using the integrity-checking information and a security key shared with the home network, an integrity of integrity-protected information (Block 630). The integrity-protected information includes (at least) the capability signaling as received by the home network. The security key may for instance be shared between an integrated circuit card (e.g., UICC) or subscriber identity module (e.g., USIM) associated with the wireless device and the home network.

In some embodiments, the method also includes, based on the integrity-protected information having integrity according to said checking, transmitting or receiving communication that is protected based on the value selected by the home network for the security parameter (Block 630). For example, in some embodiments where the security parameter is a KDF, the method may further include, based on the integrity-protected information having integrity according to said checking, deriving a security key using the value selected by the home network for the KDF, and transmitting or receiving communication that is protected by the security key or a derived security key which is derived from the security key.

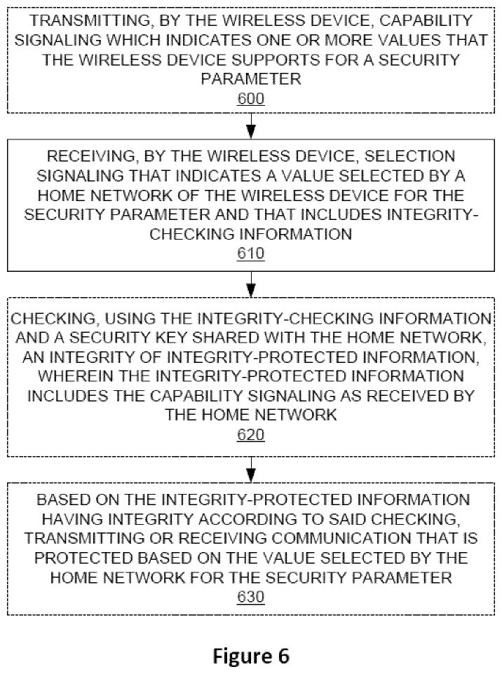

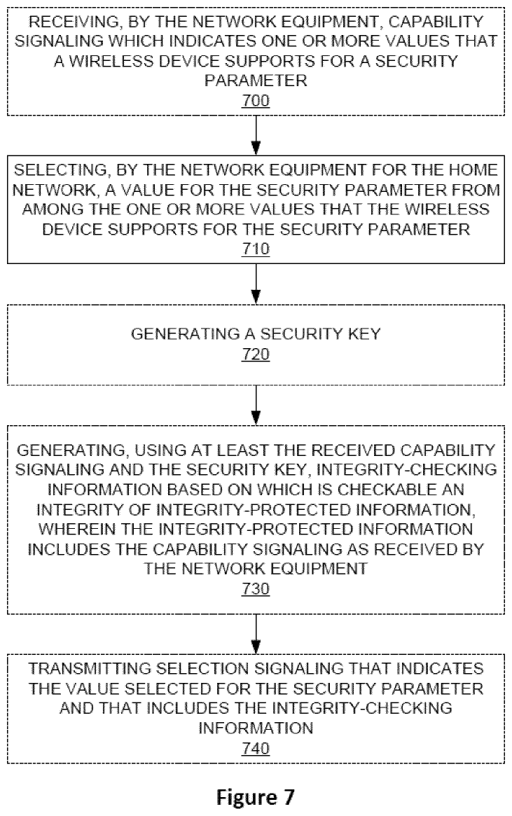

FIG. 7 depicts a method performed by network equipment configured for use in a home network of a wireless device. The method may include receiving, by the network equipment, capability signaling which indicates one or more values that a wireless device supports for a security parameter (Block 700). The method may further include selecting, by the network equipment for the home network, a value for the security parameter from among the one or more values that the wireless device supports for the security parameter (Block 710). The method in some embodiments also includes generating a security key (Block 720). The security key may for instance be shared between an integrated circuit card (e.g., UICC) or subscriber identity module (e.g., USIM) associated with the wireless device and the home network. Regardless, the method may further include generating, using at least the received capability signaling and the security key, integrity-checking information based on which is checkable an integrity of integrity-protected information (Block 730). The integrity-protected information includes (at least) the capability signaling as received by the network equipment. In any event, the method also includes transmitting selection signaling that indicates the value selected for the security parameter and that includes the integrity-checking information (Block 740).

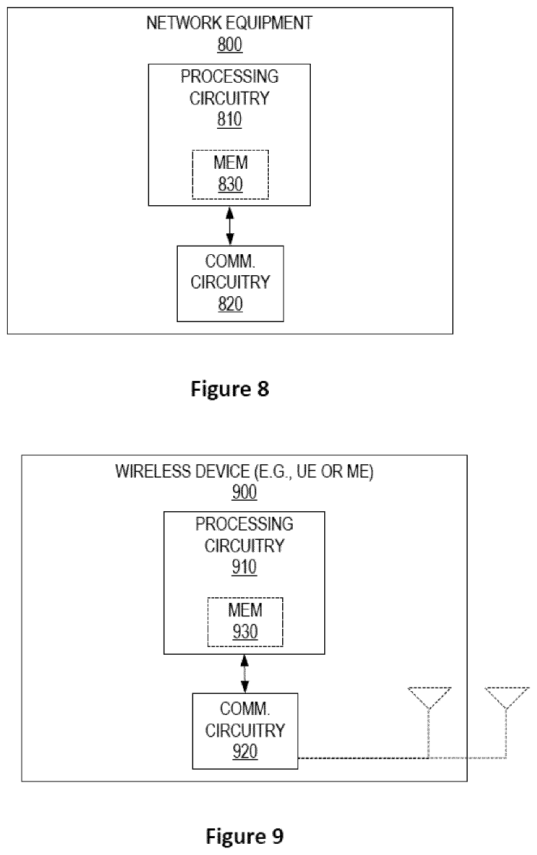

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein. FIG. 8 illustrates network equipment 800 as implemented in accordance with one or more embodiments. As shown, the network equipment 800 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 7, such as by executing instructions stored in memory 830. The processing circuitry 810 in this regard may implement certain functional means, units, or modules.

FIG. 9 illustrates a wireless device 900 (e.g., wireless device 12, UE, or ME) as implemented in accordance with one or more embodiments. As shown, the wireless device 900 includes processing circuitry 910 and communication circuitry 920. The communication circuitry 920 (e.g., radio circuitry) is configured to transmit and/or receive information to and/or from one or more other nodes, e.g., via any communication technology. Such communication may occur via one or more antennas that are either internal or external to the wireless device 900. The processing circuitry 910 is configured to perform processing described above (e.g., in FIG. 6), such as by executing instructions stored in memory 930. The processing circuitry 910 in this regard may implement certain functional means, units, or modules. Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

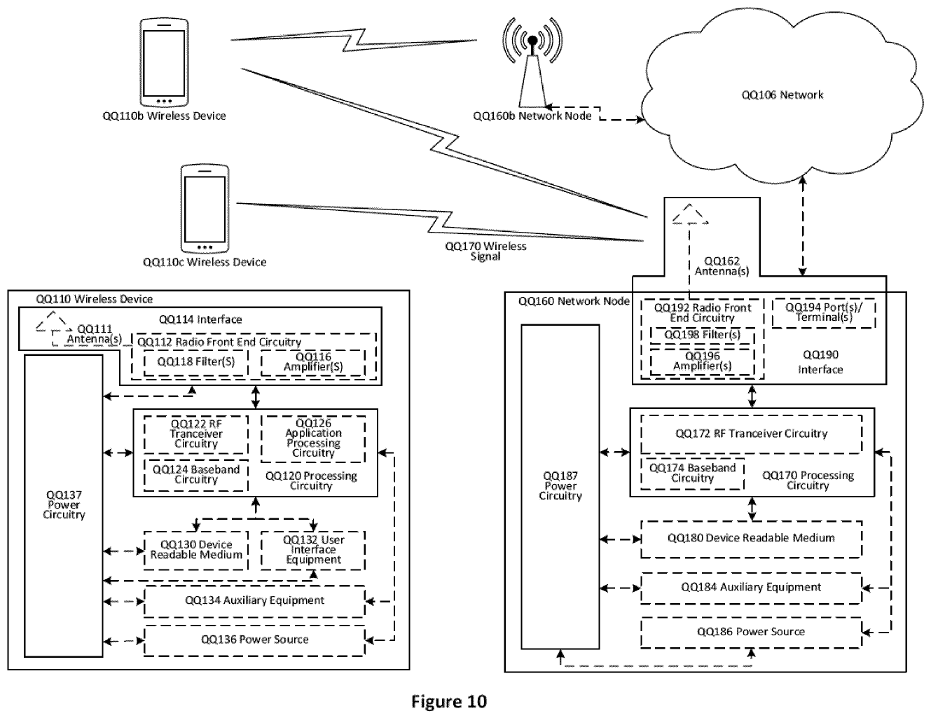

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network QQ106, network nodes QQ160 and QQ160b, and WDs QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures.

Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network equipment refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network equipment include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. Network equipment may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network equipment include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network equipment (e.g., MSCs, MMEs), O&M nodes, OSS nodes, SON nodes, positioning nodes (e.g., E-SMLCs), and/or MDTs. As another example, network equipment may implement a virtual network node as described in more detail below. More generally, however, network equipment may represent any suitable device (or group of devices) capable, configured, arranged, and/or operable to enable and/or provide a wireless device with access to the wireless network or to provide some service to a wireless device that has accessed the wireless network. In the below description, the term network node is used interchangeably with network equipment.

In FIG. 10, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination. Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160.

Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used. Alternative embodiments of network node QQ160 may include additional components beyond those shown in FIG. 10 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

A WD as used herein may in some embodiments refer more particularly to a mobile equipment (ME), as distinguished from an integrated circuit card (e.g., universal integrated circuit card, UICC) associated with the ME or a subscriber identity module (e.g., universal subscriber identity module, USIM) executed on the integrated circuit card. The integrated circuit card or subscriber identity module may be any type of integrated circuit or application, respectively, on which is stored a subscriber identity and/or preconfigured/preshared security key(s).

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination. Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

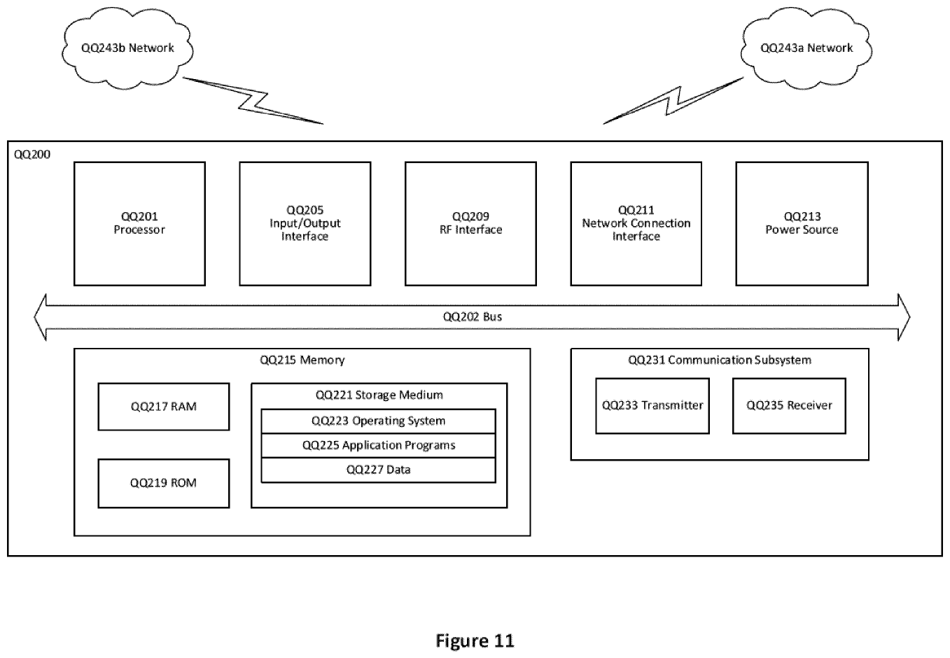

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 11, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

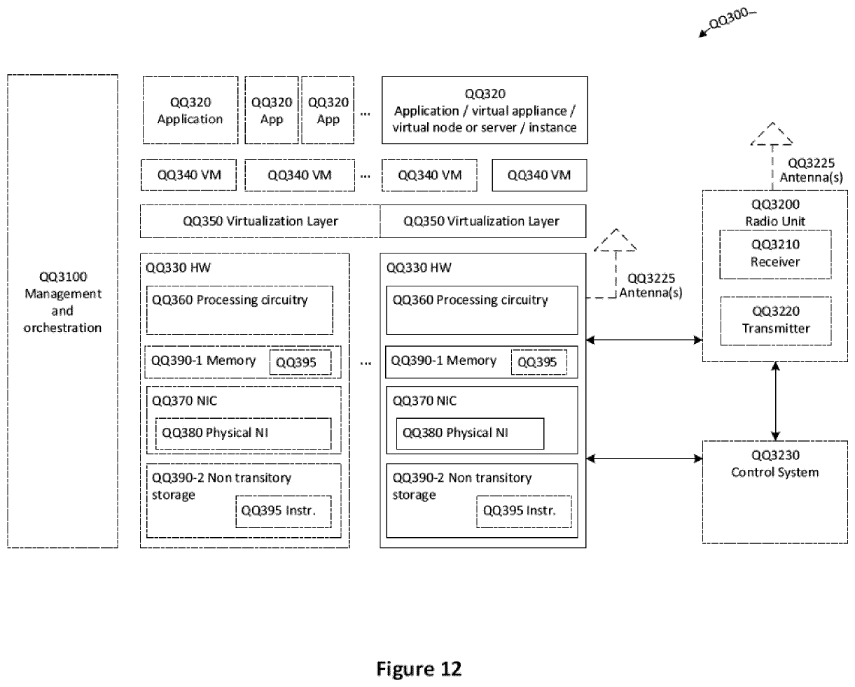

FIG. 12 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 12, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 12.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

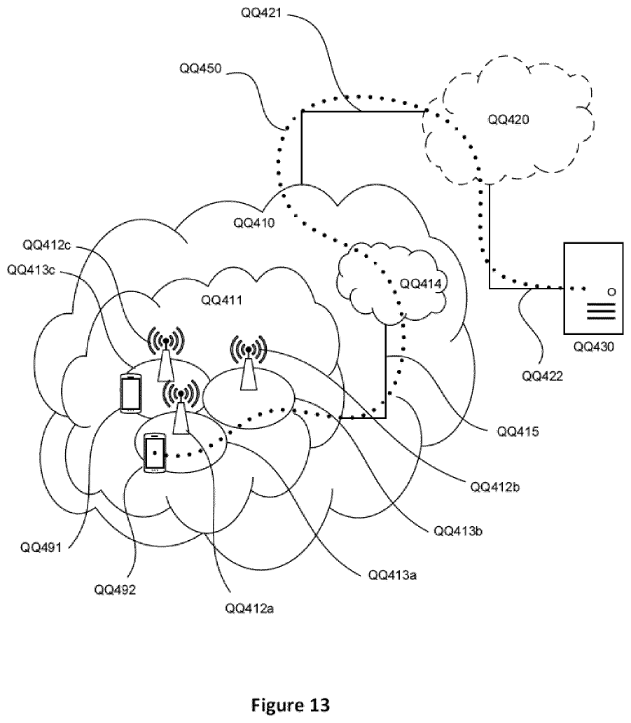

FIG. 13 illustrates a telecommunication network connected via an intermediate network to a host computer in accordance with some embodiments. In particular, with reference to FIG. 13, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 13 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

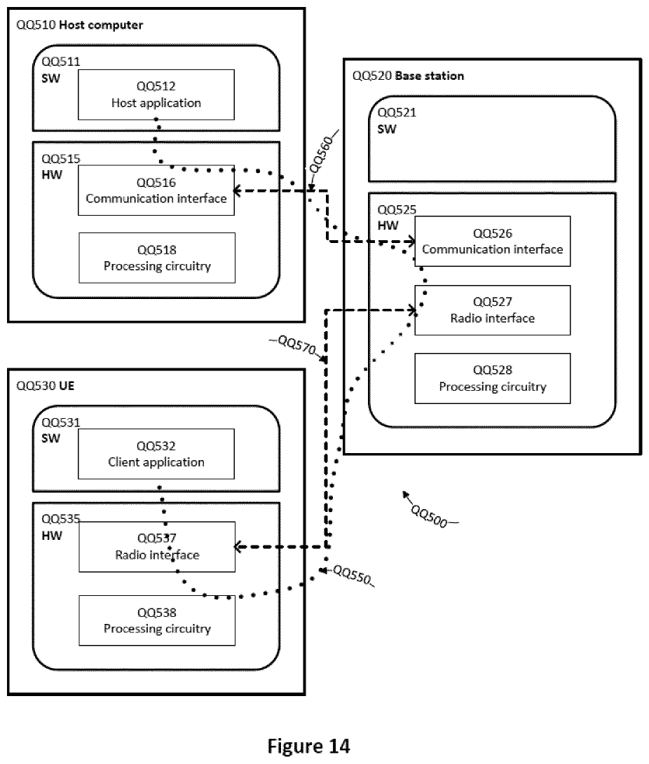

Example implementations, in accordance with an embodiment, of the UE, base station and host computer discussed in the preceding paragraphs will now be described with reference to FIG. 14. FIG. 14 illustrates host computer communicating via a base station with a user equipment over a partially wireless connection in accordance with some embodiments. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 14) served by base station QQ520. Communication interface QQ526 may be configured to facilitate connection QQ560 to host computer QQ510. Connection QQ560 may be direct or it may pass through a core network (not shown in FIG. 14) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 14 may be similar or identical to host computer QQ430, one of base stations QQ412a, QQ412b, QQ412c and one of UEs QQ491, QQ492 of FIG. 13, respectively. This is to say, the inner workings of these entities may be as shown in FIG. 14 and independently, the surrounding network topology may be that of FIG. 13.

In FIG. 14, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment. More precisely, the teachings of these embodiments may improve the security of security parameter (e.g., KDF) negotiation, e.g., against bidding-down attacks, denial-of-service attacks, etc., and thereby provide benefits such as system security, system reliability, and/or conservation of system resources.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

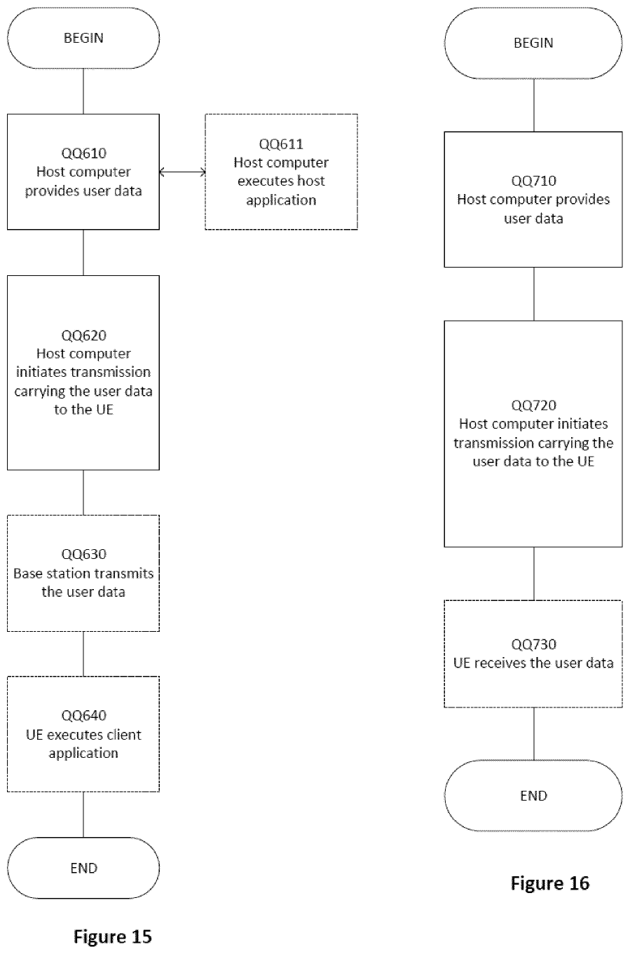

FIG. 15 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 15 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 16 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 16 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

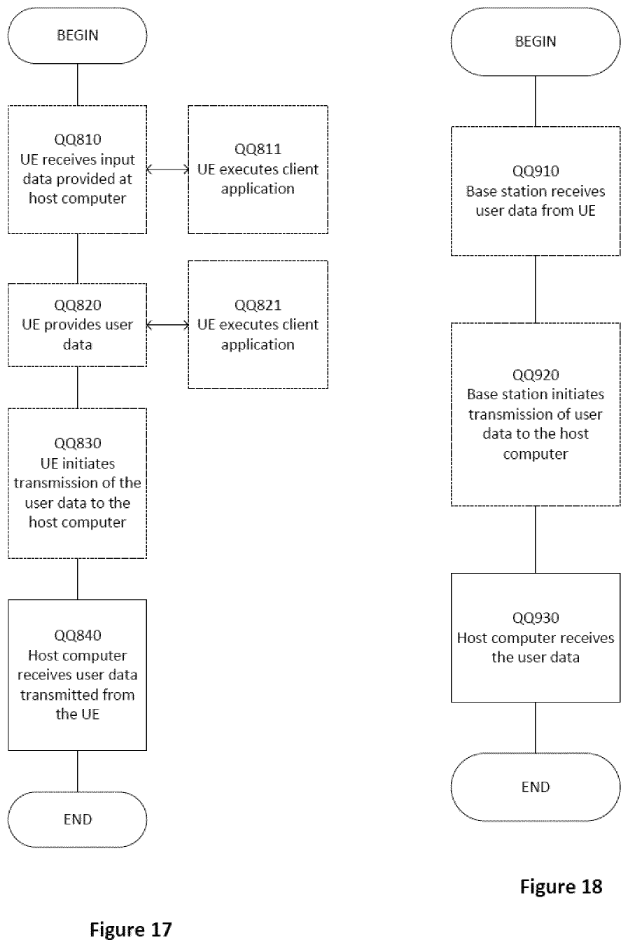

FIG. 17 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 17 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 18 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### EMBODIMENTS

### Group A Embodiments

A1. A method performed by a wireless device, the method comprising:

transmitting, by the wireless device, capability signaling which indicates one or more values that the wireless device supports for a security parameter;
receiving, by the wireless device, selection signaling that indicates a value selected by a home network of the wireless device for the security parameter and that includes integrity-checking information; and
checking, using the integrity-checking information and a security key shared with the home network, an integrity of integrity-protected information, wherein the integrity-protected information includes the capability signaling as received by the home network.

A2. The method of embodiment A1, wherein said checking comprises:

computing an integrity check using at least the transmitted capability signaling and the security key; and
determining whether or not the integrity-protected information has integrity based respectively on whether or not the integrity check equals or corresponds to the integrity-checking information.

A3. The method of embodiment A2, wherein computing the integrity check comprises computing the integrity check using at least the transmitted capability signaling, the security key, and the value selected by the home network for the security parameter.

A4. The method of any of embodiments A2-A3, wherein computing the integrity check comprises computing the integrity check using at least the transmitted capability signaling as input to a keyed version of a certain type of security algorithm, wherein the keyed version of the certain type of security algorithm is keyed by the security key.

A5. The method of embodiment A4, wherein the security parameter is a security algorithm, wherein the one or more values indicated by the capability signaling indicate one or more types of security algorithms that the wireless device supports, and wherein the value selected by the home network for the security parameter indicates the certain type of security algorithm.

A6. The method of any of embodiments A4-A5, wherein the certain type of security algorithm is a certain type of key derivation function.

A7. The method of any of embodiments A4-A5, wherein the certain type of security algorithm is a certain type of message authentication code algorithm or a certain type of digital signature algorithm.

A8. The method of any of embodiments A2-A7, wherein the integrity check comprises a key, a hash, a message authentication code, or a digital signature.

A9. The method of any of embodiments A1-A8, wherein the security parameter is a key derivation function, KDF, wherein the one or more values indicated by the capability signaling indicates one or more types of KDFs that the wireless device supports, and wherein the value selected by the home network for the security parameter indicates a certain type of KDF selected by the home network.

A10. The method of embodiment A9, wherein the security parameter is an ARPF-KDF or an AUSF-KDF.

A11. The method of any of embodiments A1-A8, wherein the security parameter is an encryption algorithm, an integrity algorithm, or a security protocol.

A12. The method of any of embodiments A1-A11, wherein the security key is an integrity key IK or a derivative thereof, a confidentiality key CK or a derivative thereof, or a combination of the integrity key IK and the confidentiality key CK.

A13. The method of any of embodiments A1-A12, wherein said checking is performed also using the value selected by the home network for the security parameter.

A14. The method of any of embodiments A1-A13, wherein receiving the selection signaling comprises receiving an authentication request message that includes the selection signaling and that requests the wireless device to authenticate itself to the home network.

A15. The method of any of embodiments A1-A14, wherein transmitting the capability signaling comprises transmitting the capability signaling within a registration request or an attach request.

A16. The method of any of embodiments A1-A15, wherein the wireless device comprises a mobile equipment, ME, configured for use with an integrated circuit card.

A17. The method of embodiment A16, wherein the capability signaling indicates one or more values that the ME supports for the security parameter.

A18. The method of any of embodiments A16-A17, wherein said checking is performed by the ME.

A19. The method of any of embodiments A1-A18, wherein transmitting the capability signaling comprises transmitting a message that includes the capability signaling, and wherein the integrity-protected information comprises the message or a portion of the message that includes the capability signaling.

A20. The method of any of embodiments A1-A19, wherein the integrity-protected information also includes the value selected by the home network for the security parameter.

A21. The method of any of embodiments A1-A20, further comprising, based on the integrity-protected information having integrity according to said checking, transmitting or receiving communication that is protected based on the value selected by the home network for the security parameter.

A22. The method of any of embodiments A1-A21, wherein the security parameter is a key derivation function, KDF, and wherein the method further comprises:

based on the integrity-protected information having integrity according to said checking, deriving a security key using the value selected by the home network for the KDF; and
transmitting or receiving communication that is protected by the security key or a derived security key which is derived from the security key.

### Group B Embodiments

B1. A method performed by network equipment configured for use in a home network of a wireless device, the method comprising:

receiving, by the network equipment, capability signaling which indicates one or more values that a wireless device supports for a security parameter;
selecting, by the network equipment for the home network, a value for the security parameter from among the one or more values that the wireless device supports for the security parameter;
generating a security key;
generating, using at least the received capability signaling and the security key, integrity-checking information based on which is checkable an integrity of integrity-protected information, wherein the integrity-protected information includes the capability signaling as received by the network equipment; and
transmitting selection signaling that indicates the value selected for the security parameter and that includes the integrity-checking information.

B2. The method of embodiment B1, wherein receiving the capability signaling comprises receiving an authentication get request message that requests authentication information from the network equipment and that includes the capability signaling, and wherein transmitting the selection signaling comprises transmitting an authentication get response message that responds to the authentication get request message with the authentication information and that includes the selection signaling.

B3. The method of any of embodiments B1-B2, wherein generating the integrity-checking information comprises generating the integrity-checking information using at least the received capability signaling, the security key, and the value selected for the security parameter.

B4. The method of any of embodiments B1-B3, wherein generating the integrity-checking information comprises generating the integrity-checking information using at least the received capability signaling as input to a keyed version of a certain type of security algorithm, wherein the keyed version of the certain type of security algorithm is keyed by the security key.

B5. The method of embodiment B4, wherein the security parameter is a security algorithm, wherein the one or more values indicated by the capability signaling indicate one or more types of security algorithms that the wireless device supports, and wherein the value selected by the home network for the security parameter indicates the certain type of security algorithm.

B6. The method of any of embodiments B5-B6, wherein the certain type of security algorithm is a certain type of key derivation function.

B7. The method of any of embodiments B5-B6, wherein the certain type of security algorithm is a certain type of message authentication code algorithm or a certain type of digital signature algorithm.

B8. The method of any of embodiments B1-B7, wherein the integrity-checking information comprises a key, a hash, a message authentication code, or a digital signature.

B9. The method of any of embodiments B1-138, wherein the security parameter is a key derivation function, KDF, wherein the one or more values indicated by the capability signaling indicates one or more types of KDFs that the wireless device supports, and wherein the value selected by the network equipment for the security parameter indicates a certain type of KDF selected by the home network.

B10. The method of embodiment B9, wherein the security parameter is an ARPF-KDF or an AUSF-KDF.

B11. The method of any of embodiments B1-610, wherein the security parameter is an encryption algorithm, an integrity algorithm, or a security protocol.

B12. The method of any of embodiments B1-611, wherein the security key is an integrity key IK or a derivative thereof, a confidentiality key CK or a derivative thereof, or a combination of the integrity key IK and the confidentiality key CK.

B13. The method of any of embodiments B1-B12, wherein the capability signaling indicates one or more values that a mobile equipment, ME, of the wireless device supports for the security parameter.

B14. The method of any of embodiments B1-B13, wherein receiving the capability signaling comprises receiving a message that includes the capability signaling, and wherein the integrity-protected information comprises the message or a portion of the message that includes the capability signaling.

B15. The method of any of embodiments B1-B14, wherein the integrity-protected information also includes the value selected for the security parameter.

B16. The method of any of embodiments B1-B15, wherein the wireless device comprises a mobile equipment, ME, configured for use with an integrated circuit card.

B17. The method of embodiment B16, wherein the capability signaling indicates one or more values that the ME supports for the security parameter.

### Group C Embodiments

C1. A wireless device comprising:

processing circuitry and memory, the memory containing instructions executable by the processing circuitry whereby the wireless device is configured to perform any of the steps of any of the Group A embodiments.

C2. A user equipment (UE) comprising:

an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and a battery connected to the processing circuitry and configured to supply power to the UE.

C3. Network equipment comprising:

processing circuitry and memory, the memory containing instructions executable by the processing circuitry whereby the network equipment is configured to perform any of the steps of any of the Group B embodiments.

### Group D Embodiments

D1. A communication system including a host computer comprising:

processing circuitry configured to provide user data; and a communication interface configured to forward the user data to a cellular network for transmission to a user equipment (UE),
wherein the cellular network comprises network equipment having a communication interface and processing circuitry, the network equipment's processing circuitry configured to perform any of the steps of any of the Group B embodiments.

D2. The communication system of the pervious embodiment further including the network equipment.

D3. The communication system of the previous 2 embodiments, further including the UE, wherein the UE is configured to communicate with the network equipment.

D4. The communication system of the previous 3 embodiments, wherein:

the processing circuitry of the host computer is configured to execute a host application, thereby providing the user data; and
the UE comprises processing circuitry configured to execute a client application associated with the host application.

D5. A method implemented in a communication system including a host computer, network equipment and a user equipment (UE), the method comprising:

at the host computer, providing user data; and
at the host computer, initiating a transmission carrying the user data to the UE via a cellular network comprising the network equipment, wherein the network equipment performs any of the steps of any of the Group B embodiments.

D6. The method of the previous embodiment, further comprising, at the network equipment, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with network equipment, the UE comprising a radio interface and processing circuitry configured to perform any of the previous 3 embodiments.

D9. A communication system including a host computer comprising:

processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes network equipment configured to communicate with the UE.

D11. The communication system of the previous 2 embodiments, wherein:

the processing circuitry of the host computer is configured to execute a host application, thereby providing the user data; and
the UE's processing circuitry is configured to execute a client application associated with the host application.

D12. A method implemented in a communication system including a host computer, network equipment and a user equipment (UE), the method comprising:

at the host computer, providing user data; and
at the host computer, initiating a transmission carrying the user data to the UE via a cellular network comprising the network equipment, wherein the UE performs any of the steps of any of the Group A embodiments.

D13. The method of the previous embodiment, further comprising at the UE, receiving the user data from the network equipment.

D14. A communication system including a host computer comprising:

communication interface configured to receive user data originating from a transmission from a user equipment (UE),
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including network equipment, wherein the network equipment comprises a communication interface configured to communicate with the UE.

D17. The communication system of the previous 3 embodiments, wherein:

the processing circuitry of the host computer is configured to execute a host application; and
the UE's processing circuitry is configured to execute a client application associated with the host application, thereby providing the user data.

D18. The communication system of the previous 4 embodiments, wherein:

the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, network equipment and a user equipment (UE), the method comprising:

at the host computer, receiving user data transmitted from the UE, wherein the UE performs any of the steps of any of the Group A embodiments.

D20. The method of the previous embodiment, further comprising:

at the UE, executing a client application, thereby providing the user data to be transmitted; and
at the host computer, executing a host application associated with the client application.

D21. The method of the previous 2 embodiments, further comprising:

at the UE, executing a client application; and
at the UE, receiving input data to the client application, the input data being provided at the host computer by executing a host application associated with the client application,
wherein the user data to be transmitted is provided by the client application in response to the input data.

D22. A communication system including a host computer comprising a communication interface configured to receive user data originating from a transmission from a user equipment (UE) via a cellular network that includes network equipment, wherein the network equipment comprises a communication interface and processing circuitry, the network equipment's processing circuitry configured to perform any of the steps of any of the Group B embodiments.

D23. The communication system of the previous embodiment further including the network equipment.

D24. The communication system of the previous 2 embodiments, further including the UE, wherein the UE is configured to communicate with the network equipment.

D25. The communication system of the previous 3 embodiments, wherein:

the processing circuitry of the host computer is configured to execute a host application;
the UE is configured to execute a client application associated with the host application, thereby providing the user data to be received by the host computer.

D26. A method implemented in a communication system including a host computer, network equipment and a user equipment (UE), the method comprising:

at the host computer, receiving, user data originating from the UE, wherein the UE performs any of the steps of any of the Group A embodiments.

1.-47. (canceled)

48. A method performed by a wireless device, the method comprising:
transmitting, by the wireless device, capability signaling which indicates one or more values that the wireless device supports for a security parameter;
receiving, by the wireless device, selection signaling that indicates a value selected by a home network of the wireless device for the security parameter and that includes integrity-checking information; and
checking, using the integrity-checking information and a security key shared with the home network, an integrity of integrity-protected information, wherein the integrity-protected information includes the capability signaling as received by the home network.

49. The method of claim 48, wherein said checking comprises:
computing an integrity check using at least the transmitted capability signaling and the security key; and
determining whether or not the integrity-protected information has integrity based respectively on whether or not the integrity check equals or corresponds to the integrity-checking information.

50. The method of claim 49, wherein computing the integrity check comprises computing the integrity check using at least the transmitted capability signaling, the security key, and the value selected by the home network for the security parameter.

51. The method of claim 49, wherein computing the integrity check comprises computing the integrity check using at least the transmitted capability signaling as input to a keyed version of a certain type of security algorithm, wherein the keyed version of the certain type of security algorithm is keyed by the security key.

52. The method of claim 48, wherein the security parameter is a key derivation function (KDF) wherein the one or more values indicated by the capability signaling indicates one or more types of KDFs that the wireless device supports, and wherein the value selected by the home network for the security parameter indicates a certain type of KDF selected by the home network.

53. The method of claim 48, wherein said checking is performed also using the value selected by the home network for the security parameter.

54. The method of claim 48, wherein receiving the selection signaling comprises receiving an authentication request message that includes the selection signaling and that requests the wireless device to authenticate itself to the home network.

55. The method of claim 48, wherein transmitting the capability signaling comprises transmitting the capability signaling within a registration request or an attach request

56. The method of claim 48, wherein the wireless device comprises a mobile equipment (ME) configured for use with an integrated circuit card.

57. A method performed by network equipment configured for use in a home network of a wireless device, the method comprising:
receiving, by the network equipment, capability signaling which indicates one or more values that a wireless device supports for a security parameter;
selecting, by the network equipment for the home network, a value for the security parameter from among the one or more values that the wireless device supports for the security parameter;
generating a security key;
generating, using at least the received capability signaling and the security key, integrity-checking information based on which is checkable an integrity of integrity-protected information, wherein the integrity-protected information includes the capability signaling as received by the network equipment; and
transmitting selection signaling that indicates the value selected for the security parameter and that includes the integrity-checking information.

58. The method of claim 57, wherein receiving the capability signaling comprises receiving an authentication get request message that requests authentication information from the network equipment and that includes the capability signaling, and wherein transmitting the selection signaling comprises transmitting an authentication get response message that responds to the authentication get request message with the authentication information and that includes the selection signaling.

59. The method of claim 57, wherein generating the integrity-checking information comprises generating the integrity-checking information using at least the received capability signaling, the security key, and the value selected for the security parameter.

60. The method of claim 57, wherein generating the integrity-checking information comprises generating the integrity-checking information using at least the received capability signaling as input to a keyed version of a certain type of security algorithm, wherein the keyed version of the certain type of security algorithm is keyed by the security key.

61. The method of claim 57, wherein the security parameter is a key derivation function (KDF) wherein the one or more values indicated by the capability signaling indicates one or more types of KDFs that the wireless device supports, and wherein the value selected by the network equipment for the security parameter indicates a certain type of KDF selected by the home network.

62. The method of claim 57, wherein the capability signaling indicates one or more values that a mobile equipment (ME) of the wireless device supports for the security parameter.

63. The method of claim 57, wherein receiving the capability signaling comprises receiving a message that includes the capability signaling, and wherein the integrity-protected information comprises the message or a portion of the message that includes the capability signaling.

64. The method of claim 57, wherein the wireless device comprises a mobile equipment (ME) configured for use with an integrated circuit card.

65. A wireless device comprising:
processing circuitry and memory, the memory containing instructions executable by the processing circuitry whereby the wireless device is configured to:
transmit capability signaling which indicates one or more values that the wireless device supports for a security parameter;
receive selection signaling that indicates a value selected by a home network of the wireless device for the security parameter and that includes integrity-checking information; and
check, using the integrity-checking information and a security key shared with the home network, an integrity of integrity-protected information, wherein the integrity-protected information includes the capability signaling as received by the home network.

66. Network equipment comprising:
processing circuitry and memory, the memory containing instructions executable by the processing circuitry whereby the network equipment is configured to:
receive capability signaling which indicates one or more values that a wireless device supports for a security parameter;
select a value for the security parameter from among the one or more values that the wireless device supports for the security parameter;
generate a security key;
generate, using at least the received capability signaling and the security key, integrity-checking information based on which is checkable an integrity of integrity-protected information, wherein the integrity-protected information includes the capability signaling as received by the network equipment; and
transmit selection signaling that indicates the value selected for the security parameter and that includes the integrity-checking information.
